(19) United States
(12) Patent Application Publication
(10) Pub. No.: US 2015/0371130 A1
(43) Pub. Date: Dec. 24, 2015

(54) POSITION-DETECTING RADIO FREQUENCY IDENTIFICATION DEVICE AND METHOD THEREOF

(71) Applicants: Tai-Hwa Liu, Hsinchu City (TW); Yi-Chun Sung, Hsinchu City (TW)

(72) Inventors: Tai-Hwa Liu, Hsinchu City (TW); Yi-Chun Sung, Hsinchu City (TW)

(21) Appl. No.: 14/308,809

(22) Filed: Jun. 19, 2014

(51) Int. Cl. G06K 19/077; G06K 7/10; G06K 19/07; H01Q 1/22

(52) U.S. Cl. CPC G06K 19/07794; H01Q 1/2225; G06K 7/10366; G06K 19/0716

(57) ABSTRACT

Provided is a position-detecting radio frequency identification (RFID) device, including a pair of radio frequency antennas transmitting and receiving a radio frequency signal, a RFID chip electrically connected to and corresponding to the pair of first radio frequency antennas, storing a signal, and stimulating the pair of radio frequency antennas into transmitting and receiving the signal, a pair of electronic switches provided between the pair of radio frequency antennas and the RFID chip, and a switch control device controlling the pair of electronic switches. Moreover, if the pair of electronic switches is in the on state, the pair of radio frequency antennas and the RFID chip are electrically connected, and if the pair of electronic switches is in the off state, the pair of radio frequency antennas and the RFID chip are electrically disconnected. Further, the present invention also provides a position-detecting RFID method.

### BACKGROUND OF THE INVENTION

1. Field of the Invention

The present invention relates generally to an electromagnetic-induction radio frequency identification (RFID) device and a method thereof, and more particularly, to a position-detecting RFID device connected to electronic switches by using a switch control device and a method thereof.

2. The Prior Arts

Generally, radio frequency identification (RFID) uses at least one RFID chip. A RFID chip stores a signal containing information, and is connected to a radio frequency antenna. The information stored in a RFID chip may be transmitted through the radio frequency antenna. RFID is widely used in a variety of applications, such as magnetic stripe cards, identification badges, labels, stickers, tracking of goods, and so on. Moreover, RFID is cheaper and smaller such that RFID may be used in many industries.

With the development of RFID, RFID attached to a machine can be used to track its information, and is often used in VLSI companies, factories or laboratories, etc. For example, a motherboard of a PC may contain a number of PCI expansion slots for PCI cards. However, if a PC contains a large number of PCI cards on a motherboard, it might be difficult to determine which PCI card is not attached to the motherboard.

On the other hands, signaling of RFIDs depends on a frequency band used by RFIDs. That is to say, RFID chips in the same frequency band will be detected, and the total number of detected RFID chips is obtained. However, position information contained in each of RFID chips may not be accurately obtained in accordance with the prior art methods.

As such, for the sake of meeting the requirements of accurately obtaining position information, determining which PCI card is attached to a motherboard and achieving low cost, it is necessary to design a device capable of providing position detection by means of RFID technology in terms of the cost effectiveness, uncomplicated structure and versatility.

Accordingly, solutions to the problems described above have been long sought, but prior developments have not taught or suggested any solutions and, thus, solutions to the problems have long eluded those skilled in the art. Therefore, there is a heretofore-unaddressed need to overcome defects and shortcomings described above.

### SUMMARY OF THE INVENTION

In light of the foregoing drawbacks, an objective of the present invention is to provide a position-detecting radio frequency identification (RFID) device, thereby overcoming the problems that RFID cannot be quickly detected and determined if a large number of RFIDs are arranged in a cabinet.

For achieving the foregoing objective, the present invention provides a position-detecting RFID device, including a pair of first radio frequency antennas transmitting and receiving a radio frequency signal, a first RFID chip electrically connected to and corresponding to the pair of first radio frequency antennas, storing a signal containing position information, and transmitting the signal having position information through the pair of first radio frequency antennas; a pair of first electronic switches electrically connected to the pair of first radio frequency antennas and the first RFID chip in series, wherein one of the pair of first electronic switches is provided between one of the pair of first radio frequency antennas and the first RFID chip, another one of the pair of first radio frequency antennas is provided between another one of the pair of the first radio frequency antenna and the first RFID chip; and a switch control device controlling the pair of first electronic switches, wherein if the pair of first electronic switches are in the on state, the pair of first radio frequency antennas and the first RFID chip are electrically connected, and if the pair of first electronic switches are in the off state, the pair of first radio frequency antennas and the first RFID chip are electrically disconnected.

Preferably, the pair of first electronic switches are a pair of light-sensitive components, the switch control device includes a pair of first light-emitting components and a light controller, the pair of light-sensitive components is sensitive to light emitted by the pair of first light-emitting components, the light controller controls the pair of first light-emitting components to emit light, and the switch control device enables the pair of first electronic switches to be in the on or off state.

Preferably, the present invention further includes a RFID chip reader electrically connected to a reader radio frequency antenna, wherein the pair of first radio frequency antennas transmits the radio frequency signal to the reader radio frequency antenna.

Preferably, the present invention further includes a RFID reader electrically connected to a reader radio frequency antenna, wherein the reader radio frequency antenna transmits the radio frequency signal to the pair of first radio frequency antennas.

Preferably, the switch control device further includes a pair of second light-emitting components, the light-controller controls the pair of second light-emitting components to emit light, and the switch control device enables a pair of second electronic switches to be in the on or off state.

Preferably, the present invention further includes a pair of second radio frequency antennas and a second RFID chip that are electrically connected to the pair of second electronic switches in series, wherein one of the pair of the second electronic switches is provided between one of the pair of second radio frequency antennas and the second RFID chip, another one of the pair of second radio frequency antennas is provided between another one of the pair of the second radio frequency antennas and the second RFID chip, and if the pair of second light-emitting components illuminates the pair of second electronic switches, the pair of second radio frequency antennas and the second RFID chip are electrically connected, and if the pair of second light-emitting components does not illuminate the pair of second electronic switches, the pair of second radio frequency antennas and the second RFID chip are electrically disconnected.

Preferably, the first RFID chip, the second RFID chip, the pair of first radio frequency antennas and the pair of second radio frequency antennas work at least one frequency band ranging from 10 KHz to 134.2 KHz, from 1 MHz to 400 MHz, from 400 MHz to 960 MHz or greater than 1 GHz.

Preferably, the pair of light-sensitive components is a pair of light-sensitive resistors, the pair of first radio frequency antennas receives a frequency outside of a frequency band when the pair of first frequency antennas and the first RFID chip are disconnected and impedance matching of the pair of first frequency antennas is affected by the pair of light-sensitive resistors.

Preferably, the pair of light-sensitive components is a pair of light-sensitive switches; the pair of first radio frequency antennas, the pair of light-sensitive switches and the first RFID chip are electrically connected in series, and the light control device enables the pair of light-sensitive switches to be in the on or off state; and if the pair of light-sensitive switches is in the on state, the pair of first radio frequency antennas and the first RFID chip are electrically connected, and if the pair of light-sensitive switches is in the off state, the pair of first radio frequency antennas and the first RFID chip are electrically disconnected.

Preferably, the pair of light-sensitive components is a pair of light-sensitive switches; the pair of first radio frequency antennas, the pair of light-sensitive switches and the first RFID chip are connected in parallel, and the light control device enables the pair of light-sensitive switches to be in the on or off state; and if the pair of light-sensitive switches is in the off state, the pair of first radio frequency antennas and the first RFID chip are electrically connected, and if the pair of light-sensitive switches is in the on state, the pair of first radio frequency antennas and the first RFID chip are electrically disconnected.

Preferably, the present invention further includes a light-sensitive energy storage component, wherein the switch control device includes a pair of first light-emitting components and a light controller, the pair of first radio frequency antennas, the pair of first electronic switches and the first RFID chip are electrically connected in series, and the light-sensitive energy storage component is connected to the pair of first electronic switches; the switch control device enables the pair of first electronic switches to be in the on or off state by illuminating the light-sensitive energy storage component; and if the pair of first electronic switches is in the on state, the pair of first radio frequency antennas and the first RFID chip are electrically connected, and if the pair of first electronic switches is in the off state, the pair of first radio frequency antennas and the first RFID chip are electrically disconnected. The light-sensitive energy storage component may provide a control voltage for the pair of first electronic switches.

Preferably, the present invention further includes a light-sensitive energy storage component, wherein the switch control device includes a pair of first light-emitting components and a light controller; the pair of first radio frequency antennas, the pair of first electronic switches and the first RFID chip are electrically connected in parallel, and the light-sensitive energy storage component is connected to the pair of first electronic switches; the switch control device enables the pair of first electronic switches to be in the on or off state by illuminates the light-sensitive energy storage component; and if the pair of first electronic switches is in the off state, the pair of first radio frequency antennas and the first RFID chip are electrically connected, and if the pair of first electronic switches is in the on state, the pair of first radio frequency antennas and the first RFID chip are electrically disconnected. Moreover, the pair of first electronic switches may be transistors. The light-sensitive energy storage component may provide a control voltage for the pair of first electronic switches.

Preferably, the first RFID chip, the pair of first electronic switches and the pair of first radio frequency antennas are mounted on a circuit board, and the pair of first light-emitting components, the light controller and the RFID reader are mounted in a cabinet or a place nearby.

Preferably, the first RFID chip, the pair of first electronic switches and the pair of first radio frequency antennas are mounted on a circuit board, and the pair of first light-emitting components, the light controller, the reader radio frequency antenna and the RFID reader are mounted in a cabinet or a place nearby.

Besides, the present invention further provides a position-detecting RFID method, including the steps of providing a pair of radio frequency antennas, a RFID chip storing a signal containing position information, an pair of electronic switches, a switch control device and a RFID reader, wherein one of the pair of electronic switches is provided between one of the pair of radio frequency antennas and the RFID chip, another one of the pair of radio frequency antennas is provided between another one of the pair of radio frequency antennas and the RFID chip, and thus the pair of radio frequency antennas, the pair of electronic switches and the RFID chip are electrically connected in series, and the switch control device controls the pair of electronic switches; enabling the pair of electronic switches to be in the off state to disconnect the RFID chip and the pair of radio frequency antennas; enabling the pair of electronic switches to be in the on state by using the switch control device while the RFID chip connected to the pair of electronic switches is detected, wherein the pair of radio frequency antennas transmits the signal containing position information stored in the RFID chip to the reader radio frequency antenna; and reading a signal having position information stored by the RFID chip by the RFID reader while the pair of electronic switches connected to the RFID chip is in the on state, and obtaining position information of the RFID chip.

Preferably, the pair of electronic switches is a pair of light-sensitive switches, the switch control device includes a pair of light-emitting components and a light controller, the light controller controls the pair of light-emitting components to emit light, and the light-emitting component illuminate the pair of light-sensitive switches to enable the pair of light-sensitive switches to be in the on state.

Preferably, the step of providing includes a step of electrically connecting the RFID chip, the pair of electronic switches and the pair of radio frequency antennas in series; if the pair of electronic switches is in the on state, the RFID chip and the pair of radio frequency antennas are electrically connected, and if the pair of electronic switches is in the off state, the RFID chip and the pair of radio frequency antennas are electrically disconnected.

Preferably, the step of providing includes a step of electrically connecting the RFID chip, the pair of electronic switches and the pair of radio frequency antennas in parallel; if the pair of electronic switches is in the off state, the RFID chip and the pair of radio frequency antennas are connected, and if the pair of electronic switches is in the on state, the RFID chip and the pair of radio frequency antennas are disconnected.

As described above, it can clearly be seen that the pair of light-sensitive components along with the pair of light-emitting components controlled by the light controller determines whether the pair of radio frequency antennas and the RFID chip are connected. As such, if a large number of RFIDs are arranged in a cabinet, position information contained in each of RFID chips can be quickly and accurately obtained in accordance with the present invention.

Certain embodiments of the present invention have other components in addition to or in place of those mentioned above. The components will become apparent to persons skilled in the art from a reading of the following detailed description when taken with reference to the accompanying drawings.

### BRIEF DESCRIPTION OF THE DRAWINGS

The present invention will be apparent to those skilled in the art by reading the following detailed description of a preferred embodiment thereof, with reference to the attached drawings, in which:

FIGS. 1A and 1B are schematic diagrams illustrating a position-detecting radio-frequency identification (RFID) device according to the first embodiment of present invention;

FIG. 2 is a schematic diagram showing the position-detecting RFID device according to the second embodiment of the present invention;

FIG. 3 is a schematic diagram showing the position-detecting RFID device according to the third embodiment of the present invention;

FIG. 4 is a schematic diagram showing the position-detecting RFID device according to the fourth embodiment of the present invention;

FIG. 5 is a schematic diagram showing the position-detecting RFID device according to the fifth embodiment of the present invention;

FIG. 6 is a schematic diagram showing the position-detecting RFID device according to the sixth embodiment of the present invention;

FIG. 7 is a schematic diagram showing the position-detecting RFID device according to the seventh embodiment of the present invention;

FIG. 8 is a schematic diagram showing the position-detecting RFID device according to the eighth embodiment of the present invention;

FIG. 9 is a schematic diagram showing the position-detecting RFID device according to the ninth embodiment of the present invention; and

FIG. 10 is a flow chart showing a position-detection RFID method according to the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

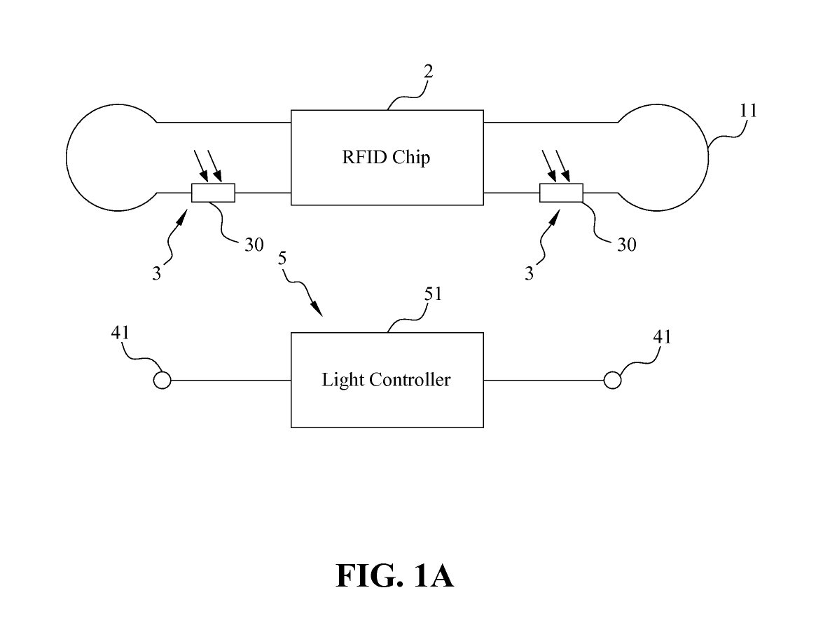

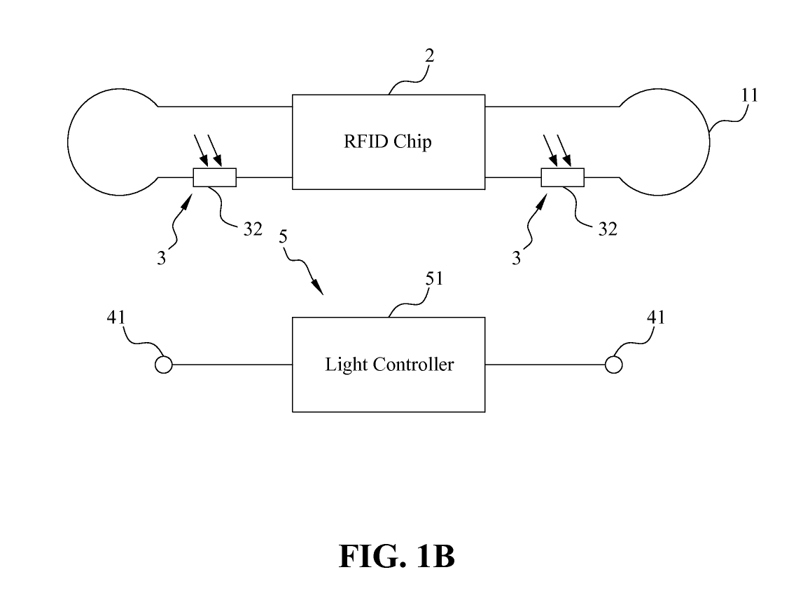

With regard to FIGS. 1-10, the drawings showing embodiments are semi-diagrammatic and not to scale and, particularly, some of the dimensions are for clarity of presentation and are shown exaggerated in the drawings. Similarly, although the views in the drawings for ease of description generally show similar orientations, this depiction in the drawings is arbitrary for the most part. Generally, the present invention can be operated in any orientation.

The present invention will be more specifically described by the followings embodiments. However, these embodiments are not intended to limit the scope of the present invention.

### First Embodiment

Referring to FIGS. 1A and 1B, a position-detecting RFID device radio frequency identification (RFID) is illustrated.

The present invention provides a position-detecting RFID device, including a pair of radio frequency antennas 11, a RFID chip 2 and a pair of electronic switches 3. One of the pair of electronic switches 3 is provided between one of the pair of radio frequency antennas 11 and the RF chip 2. Another one of the pair of radio frequency antennas 11 is provided between another one of the pair of radio frequency antennas 11 and the RFID chip 2. In addition, the pair of electronic switches 3 is controlled by a switch control device 5, as shown in FIG. 1A. Further, it should be noted that the position-detecting RFID device may also include at least one radio frequency antenna 11, a RFID chip 2 and at least one electronic switch 3.

In the first embodiment of the present invention, the pair of electronic switches 3 may be a pair of light-sensitive components 30. Moreover, the pair of light-sensitive components 30 may also be a pair of light-sensitive resistor 32, as shown in FIG. 1B. The switch control device 5 includes a light-emitting component 41 and a light controller 51. The light controller 51 controls the light-emitting component 41 to illuminate the pair of light-sensitive resistor 32. Impedance matching of the pair of radio frequency antennas 11 may be varied by changing the resistance of the light-sensitive resistor 32.

According to the first embodiment of the present invention, the pair of radio frequency antennas transmits and receives a radio frequency signal. The RFID chip 2 may transmit a signal containing position information to the pair of radio frequency antennas. The pair of radio frequency antennas may convert the signal into a radio frequency signal, and the radio frequency signal is transmitted by the pair of radio frequency antennas. As such, the pair of radio frequency antennas may include at least one frequency band ranging from 10 KHz to 134.2 KHz, from 1 MHz to 400 MHz, from 400 MHz to 960 MHz or greater than 1 GHz. The higher frequency band the pair of radio frequency antennas works, the higher transmission speed the radio frequency signal is transmitted. Moreover, the low frequency band is a short-range technology, typically requiring a transmission distance of 30 cm or less, the high frequency band is a is a long-range technology, typically requiring a transmission distance of 1 m or less, and the ultra high frequency band is a ultra long-range technology, typically requiring a transmission distance of 10 m or less (such as an antenna formed by passive components) or a transmission distance of 100 m or less (such as an antenna formed by active components). Additionally, the transmission distance with microwave antennas is up to 1 m (such as an antenna formed by passive components) or up to 50 m (such as an antenna formed by active components).

As shown in FIGS. 1A and 1B, the pair of light-sensitive components 30 is sensitive to light. In the first embodiment of the present embodiment, the pair of light-sensitive components 30 may be a pair of light-sensitive resistor 32. The resistance of the light-sensitive resistor 32 may be reduced when light illuminates the light-sensitive resistor 32. As shown in FIG. 1B, the light-sensitive resistor 32 is electrically connected to the pair of radio frequency antennas such that impedance matching of the pair of frequency antennas may be affected by the pair of light-sensitive resistors. If impedance matching of the pair of frequency antennas is not achieved, the radio frequency signal may not be transmitted by the pair of frequency antennas.

In the first embodiment of the present invention, the light controller 51 controls the light-emitting component 41 to illuminate the pair of light sensitive resistor 32. Impedance matching of the pair of radio frequency antennas may be varied by the resistance of the light-sensitive resistor 32.

### Second Embodiment

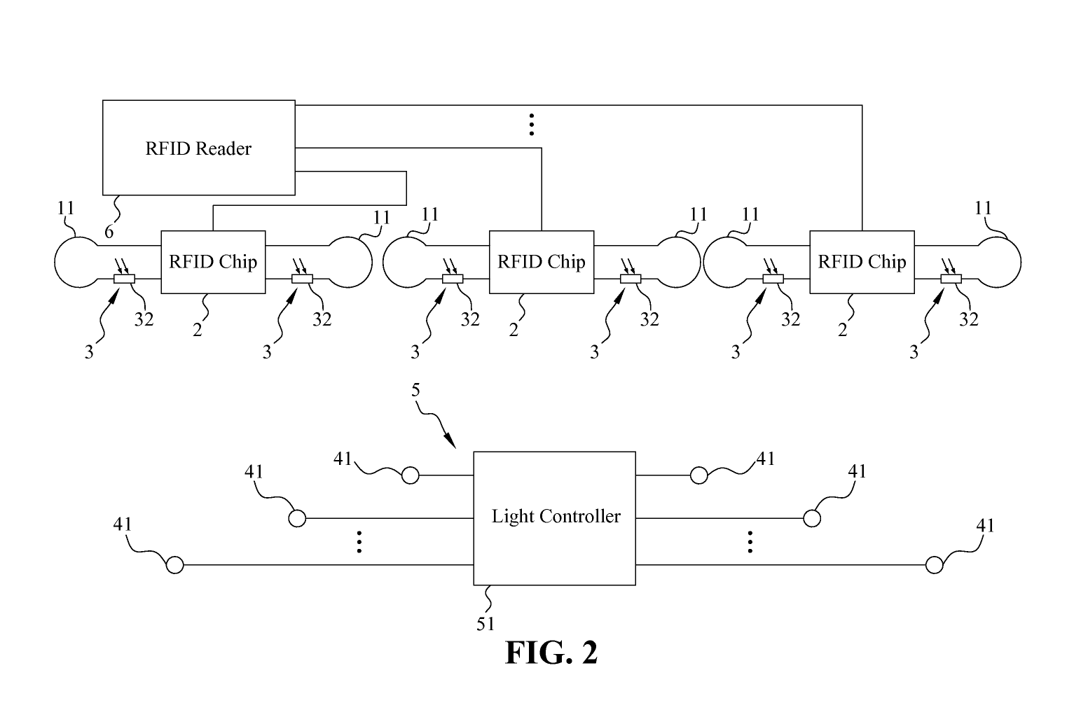

Referring to FIG. 2, a schematic diagram of the position-detecting RFID device is shown in accordance with the second embodiment of the present invention.

In the second embodiment of the present invention, the position-detecting RFID device includes a plurality of pairs of radio frequency antennas 11, a plurality of RFID chips 2, a plurality of pairs of light-sensitive resistors 32, a switch control device 5 and a RFID reader 6. In addition, the switch control controller 5 includes a plurality of pairs of light-emitting components 41 and a light controller 51. The plurality of pairs of radio frequency antennas 11, the plurality of RFID chips 2, a plurality of pairs of light-sensitive resistors 32 and the switch control device 5 are similar to those of the first embodiment of the present invention, and thus will not be repeated.

According to the second embodiment of the present invention, the RFID reader is electrically connected to the plurality of RFID chips, and receives a signal containing position information from the plurality of RFID chips.

In other words, as shown in FIG. 2, the RFID reader is electrically connected to the plurality of RFID chips. When one of the plurality of RFID chips transmits a signal having position information, the RFID reader will receive the signal.

According to the second embodiment of the present invention, the light controller 51 controls the plurality of pairs of light-emitting components 41 to illuminate the plurality of the pair of light-sensitive resistor 31. Therefore, each of the plurality of pairs of light-sensitive resistors 32 responds to each of the plurality of pairs of light-emitting components 41, as shown in FIG. 2.

### Third Embodiment

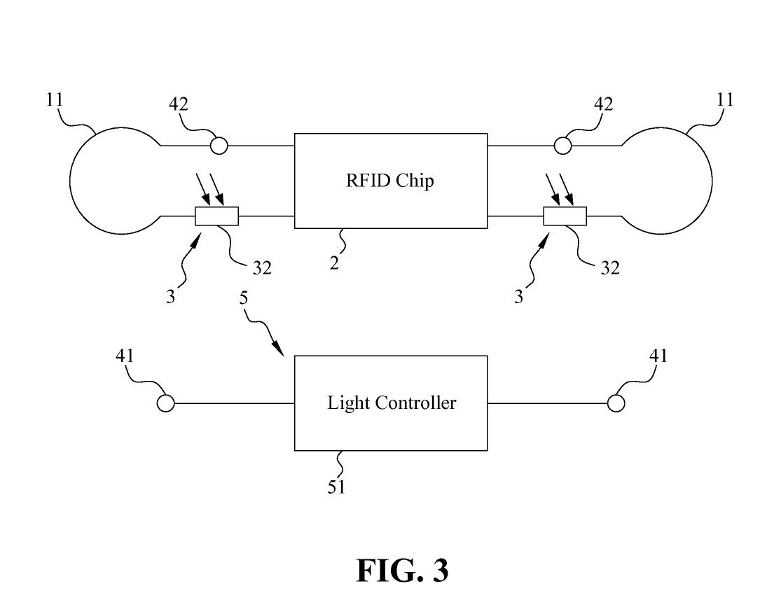

Referring to FIG. 3, the position-detecting RFID device is shown in accordance with the third embodiment of the present invention.

In the third embodiment of the present invention, the position-detecting RFID device includes a pair of radio frequency antennas 11, a RFID chip 2, a pair of light-sensitive resistors 32 (also representing a pair of electronic switches 3), a switch control device 5 composed of a pair of first light-emitting components 41 and a light controller 51, and a pair of second light-emitting components 42, as shown in FIG. 3. The pair of radio frequency antennas 11, the RFID chip 2, the pair of light-sensitive resistors 32 and the switch control device 5 are similar to those of the first embodiment of the present invention, and thus will not be repeated.

According to the third embodiment of the present invention, the pair of second light-emitting components is electrically connected to the pair of radio frequency antennas. The pair of second light-emitting components indicates whether the RFID chip is transmitting a signal containing position information to the RFID reader through the pair of radio frequency antennas. The pair of first light-emitting components and the pair of second light-emitting components may be a pair of LED components.

### Fourth Embodiment

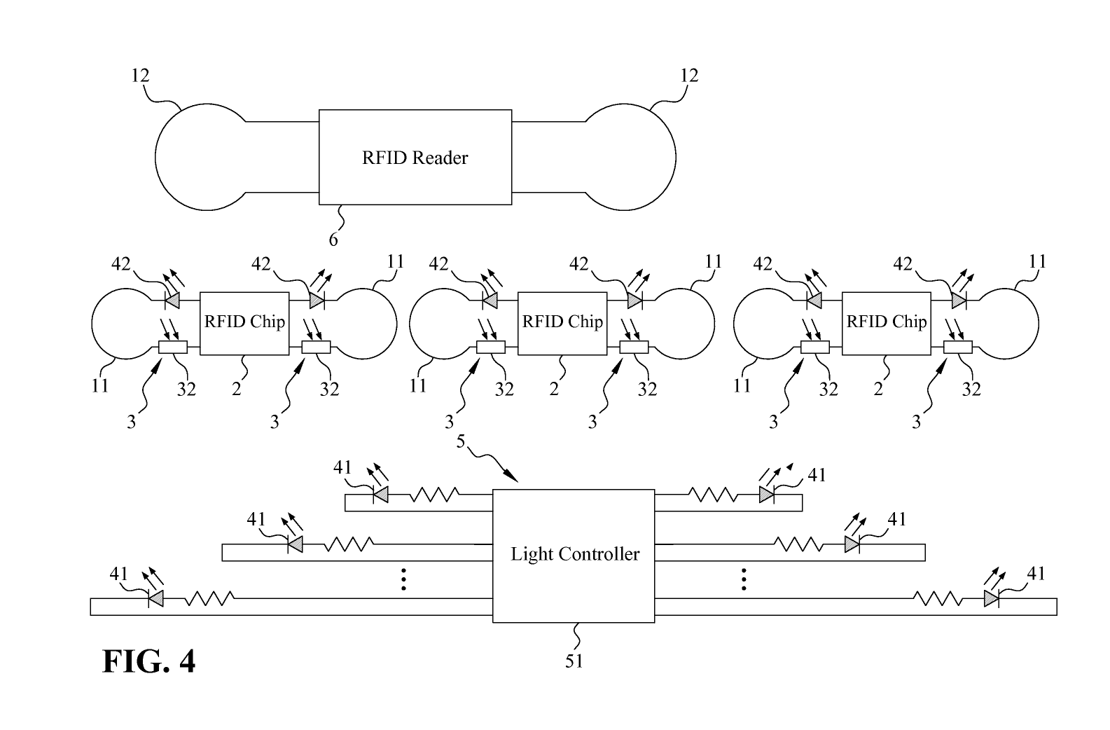

As shown in FIG. 4, a schematic diagram of the position-detecting RFID device is shown in accordance with the fourth embodiment of the present invention.

In the fourth embodiment of the present invention, the position-detecting RFID device includes a plurality of pairs of radio frequency antennas 11, a plurality of RFID chips 2, a plurality of light-sensitive resistors 32 (also representing a pair of electronic switches 3), a switch control device 5 composed of the plurality of pairs of first light-emitting components 41 and a light controller 51, a plurality of pairs of second light-emitting components 42, a pair of reader radio frequency antennas 12 and a RFID reader 6, as shown in FIG. 4. The plurality of pairs of radio frequency antennas 11, the plurality of RFID chips 2, the plurality of light-sensitive resistors 32 and the switch control device 5 are similar to those of the first and second embodiments of the present invention, and thus will not be repeated.

According to the fourth embodiment of the present invention, each of the plurality of pairs of second light-emitting components 42 is electrically connected to each of the plurality of pairs of radio frequency antennas 11. Each of the plurality of the pair of second light-emitting components 42 indicates whether its RFID chip 2 is transmitting a signal containing position information to the RFID reader 6 through its pair of radio frequency antennas 11. The plurality of pairs of first light-emitting components 41 and the plurality of pairs of second light-emitting components 42 may be a plurality of pairs of LED components. The reader radio frequency antenna 12 responds to the plurality of pairs of radio frequency antennas 11. As such, the RFID reader 6 may receive a signal containing position information from one of the plurality of RFID chips 2 via its pair of radio frequency antennas 11 and the pair of reader radio frequency antennas 12, as shown in FIG. 4.

### Fifth Embodiment

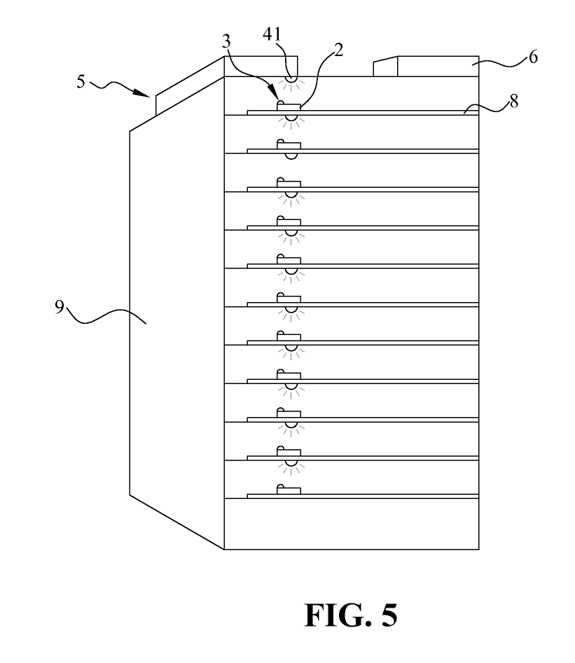

Referring to FIG. 5, a schematic diagram of the position-detecting RFID device is shown in accordance with the fifth embodiment of the present invention.

It can clearly be seen from FIG. 5 that a plurality of circuit boards 8 are mounted in a cabinet 9. In this embodiment of the present invention, it may be detected whether the plurality of circuit boards 8 are arranged in the cabinet 9. Each of the plurality of circuit boards 8 includes a pair of radio frequency antennas 11, a pair of electronic switches 3 and a RFID chip 2. A light controller 51 controls a light-emitting component 41 to illuminate the pair of electronic switches 3. Therefore, impedance matching of the pair of radio frequency antennas 11 may be varied by changing the resistance of the light-sensitive resistor 32, and a RFID reader may receive a signal containing position information from one of the RFID chips 2 mounted on one of the circuit boards 8 via an electrical connection or an antenna. That is to say, according to the present invention, it may be determined whether a circuit board 8 is arranged in the cabinet 9.

### Sixth Embodiment

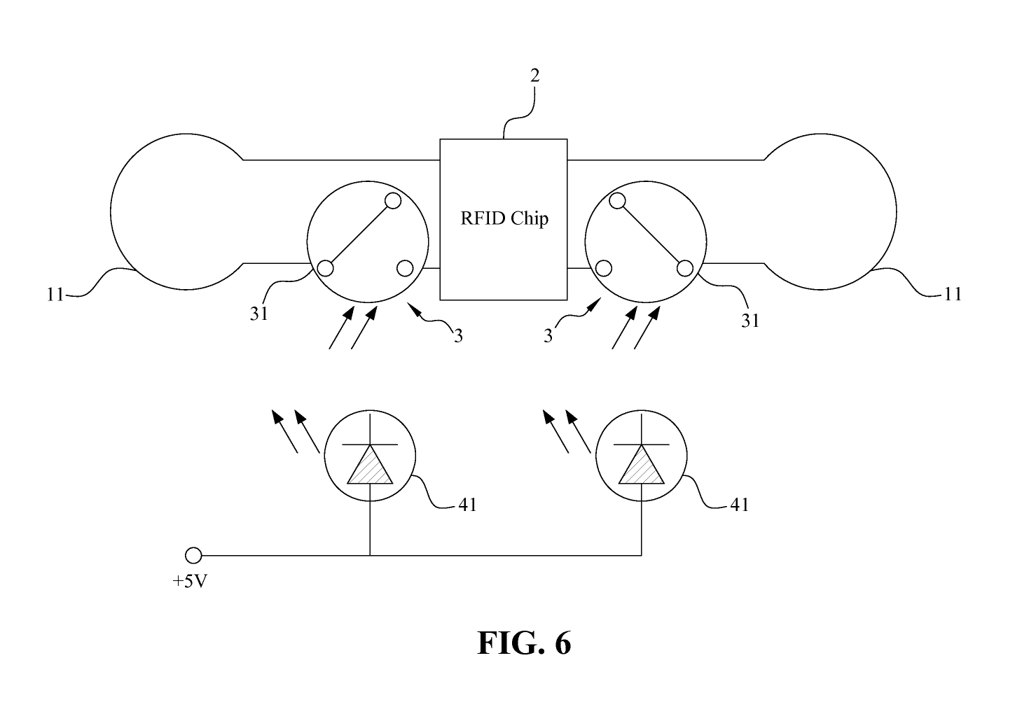

Referring to FIG. 6, a schematic diagram of the position-detecting RFID device is shown in accordance with the six embodiment of the present invention.

In the six embodiment of the present invention, one of a pair of electronic switches 3 is provided between one of a pair of radio frequency antennas 11 and a RFID chip 2, and another one of the pair of electronic switches 3 is provided between another one of the pair of radio frequency antennas 11 and the RFID chip 2. Moreover, the pair of electronic switches 3 may be a pair of light-sensitive switches 31, as shown in FIG. 6.

In other words, the pair of radio frequency antennas 11, the pair of light-sensitive switches 31 and the RFID chip 2 are electrically connected in series. A pair of light-emitting components 41 may illuminate the pair of light-sensitive switches 31. If the pair of light-emitting components 41 illuminates the pair of light-sensitive switches 31, the pair of radio frequency antennas and the RFID chip are electrically connected. The RFID chip may transmit a signal containing position information through the pair of radio frequency antennas. However, if the pair of light-emitting components 41 does not illuminate the pair of the light-sensitive switches 31, the pair of radio frequency antennas and the RFID chip are electrically disconnected. Accordingly, the RFID chip may not transmit a signal containing position information through the pair of radio frequency antennas.

### Seventh Embodiment

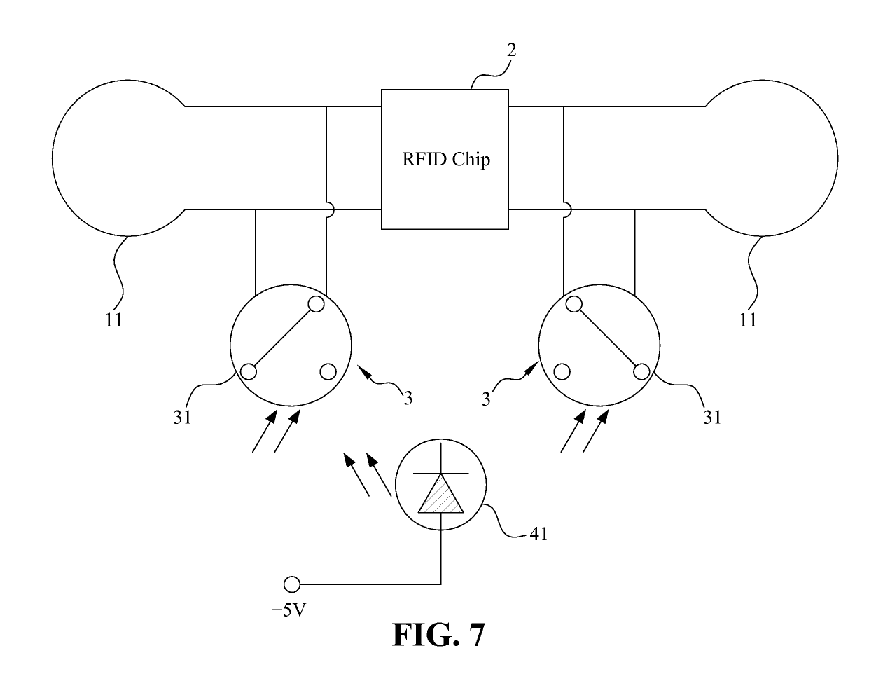

Referring to FIG. 7, a schematic diagram of the position-detecting RFID device is shown in accordance with the seventh embodiment of the present invention.

In the seventh embodiment of the present invention, the pair of radio frequency antennas, the pair of electronic switches 3 and the RFID chip are connected in parallel, as shown in FIG. 7. Additionally, the pair of electronic switches 3 may be a pair of light-sensitive switches 31.

According to the seventh embodiment of the present invention, if the pair of light-sensitive switches 31 is in the off state, the pair of radio frequency antennas 11 and the RFID chip 2 are electrically connected, and if the pair of light-sensitive switches 31 is in the on state, the pair of radio frequency antennas 11 and the RFID chip 2 are electrically disconnected.

### Eighth Embodiment

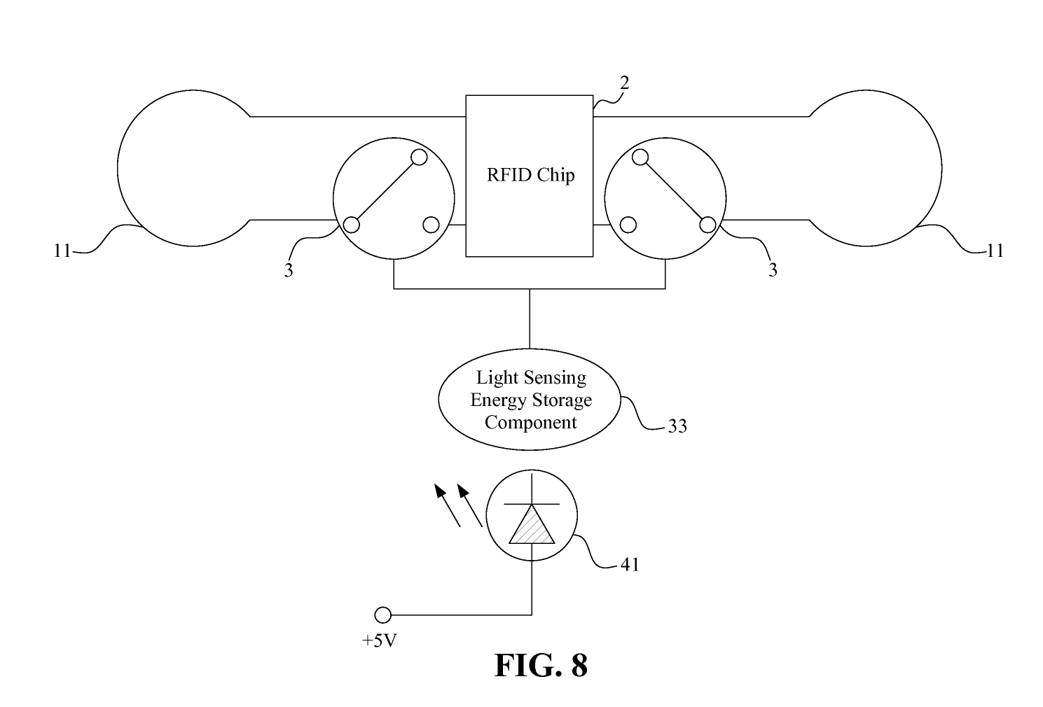

Referring to FIG. 8, a schematic diagram of the position-detecting RFID device is shown in accordance with the eighth embodiment of the present invention.

In the eighth embodiment of the present invention, the pair of antennas 11, the pair of electronic switches 3 and the RFID chip 2 are electrically connected in series. Moreover, an additional light-sensitive energy storage component 33 is electrically connected to the pair of electronic switches 3, as shown in FIG. 8.

According to the eighth embodiment of the present invention, a switch control device (not shown) enables the pair of electronic switches 3 to be in the on or off state by illuminating the light-sensitive energy storage component 33. If the pair of electronic switches 3 is in the on state, the pair of radio frequency antennas 11 and the RFID chip 2 are electrically connected. The RFID chip 2 may transmit a signal containing position information through the pair of radio frequency antennas 11. However, if the pair of electronic switches 3 is in the off state, the pair of radio frequency antennas 11 and the RFID chip 2 are electrically disconnected. In other words, the RFID chip 2 may not transmit a signal containing position information through the pair of radio frequency antennas 11.

Additionally, the pair of electronic switches 3 may be a pair of transistors, and the light-sensing energy storage component 33 is required to be supplied by a power supply unit. Therefore, the light-sensing energy storage component 33 may provide a control voltage for the pair of transistors.

### Ninth Embodiment

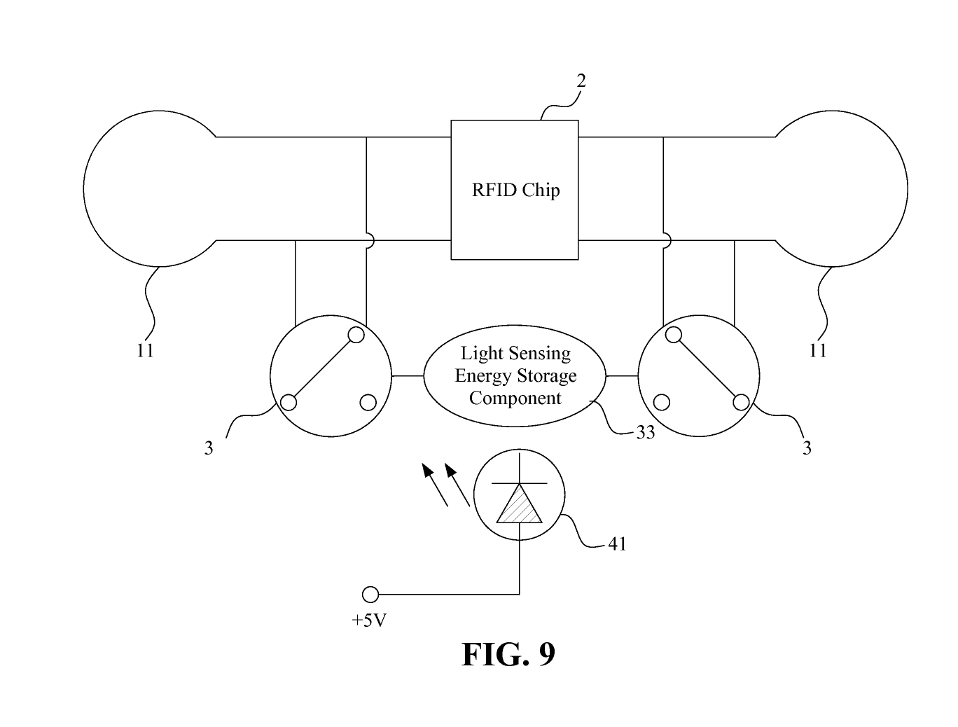

Referring to FIG. 9, a schematic diagram of the position-detecting RFID device is shown in accordance with the ninth embodiment of the present invention.

In the ninth embodiment of the present invention, a pair of radio frequency antennas 11, a pair of electronic switches 3 and a RFID chip 2 are electrically connected in parallel, as shown in FIG. 9. An additional light-sensitive energy storage component 33 is connected to the pair of electronic switches 3. A switch control device (not shown) enables the pair of electronic switches 3 to be in the on or off state by illuminating the light-sensitive energy storage component 33. That is to say, if the pair of electronic switches 3 is in the off state, the pair of radio frequency antennas 11 and the RFID chip 2 are electrically connected. The RFID chip 2 may transmit a signal incorporating position information though the pair of radio frequency antennas 11. However, if the pair of electronic switches 3 is in the on state, the pair of radio frequency antennas 11 and the RFID chip 2 are electrically disconnected. As such, the RFID chip 2 may not transmit a signal containing position information through the pair of radio frequency antennas 11, as shown in FIG. 9.

Further the pair of electronic switches 3 may be a pair of transistors and the light-sensing energy storage component 33 is required to be supplied by a power supply unit. Accordingly, the light-sensing energy storage component 33 may provide a control voltage for the pair of transistors, as shown in FIG. 9.

An Embodiment with Respect to a Position-Detecting RFID Method

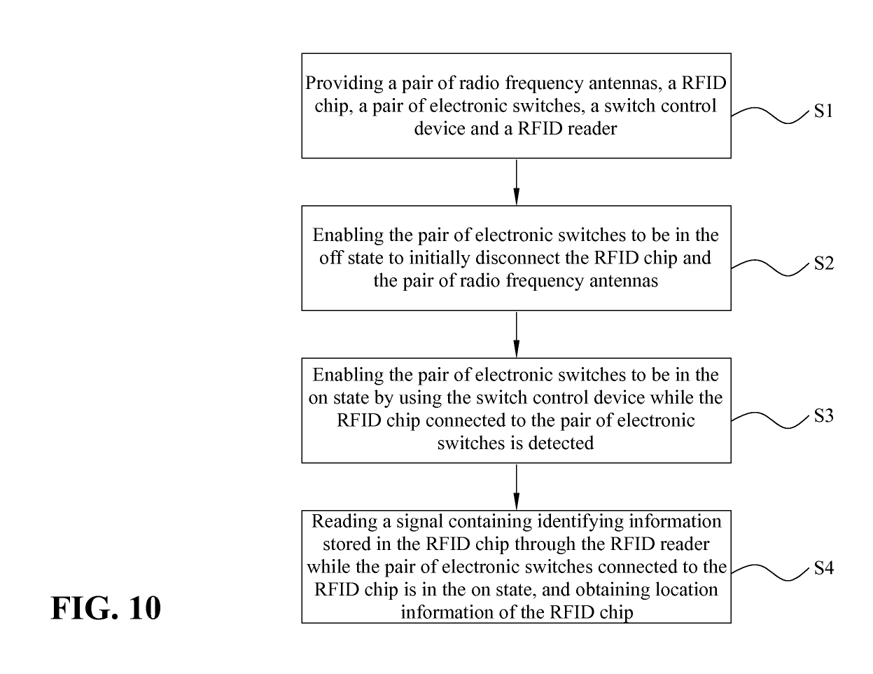

Referring to FIG. 10, a flow chart of a position-detecting RFID method is shown according to the present invention.

The present invention further provides the position-detecting RFID method. The position-detecting RFID method includes the following steps.

In step S1, a pair of radio frequency antennas, a RFID chip, a pair of electronic switches, a switch control device and a RFID reader are provided. One of the pair of electronic switches is provided between one of the pair of radio frequency antennas and the RFID chip, and another one of the pair of radio frequency antennas is provided between another one of the pair of radio frequency antennas and the RFID chip. Therefore, the pair of radio frequency antennas, the pair of electronic switches and the RFID chip are electrically connected in series. In addition, the switch control device may control the pair of electronic switches. The pair of radio frequency antennas may transmit a radio frequency signal to the reader radio frequency antenna or receive the radio frequency signal from the reader radio frequency antenna. Further, it should be noted that at least one radio frequency antenna, a RFID chip, at least one electronic switch, a switch control device and a RFID reader may also be provided.

In step S2, the pair of electronic switches is enabled to be in the off state to disconnect the RFID chip and the pair of radio frequency antennas.

In step S3, the pair of electronic switches is then enabled to be in the on state by using the switch control device while the RFID chip connected to the pair of electronic switches is detected.

In step S4, a signal containing position information stored in the RFID chip is read by the RFID reader while the pair of electronic switches connected to the RFID chip is in the on state, and thus position information of the RFID chip is obtained.

In addition, the pair of electronic switches may be a pair of light-sensitive switches. The switch control device may include a pair of light-emitting components and a light controller. The light controller controls the pair of light-emitting components. As such, the pair of light-emitting components illuminates the pair of light-sensitive switches to enable the pair of light-sensitive switches to be in the on state.

Moreover, in step S1, the RFID chip, the pair of electronic switches and the pair of radio frequency antennas may be electrically connected in series. In other words, if the pair of electronic switches is in the on state, the RFID chip and the pair of radio frequency antennas are electrically connected. However, if the pair of electronic switches is in the off state, the RFID chip and the pair of radio frequency antennas are electrically disconnected.

Further, in step S1, the RFID chip, the pair of electronic switches and the pair of radio frequency antennas are electrically connected in parallel. For example, if the pair of electronic switches is in the off state, the RFID chip and the pair of radio are electrically connected, but if the pair of electronic switches is in the on state, the RFID and the pair of radio frequency antennas are electrically disconnected.

Besides, the devices described in relation to the first embodiment to the ninth embodiment are all applicable to this embodiment. Accordingly, a low-cost and simplified position-detecting RFID device is achieved according to the embodiments of the present invention.

The above exemplary embodiment describes the principle and effect of the present invention, but is not limited to the present invention. It will be apparent to those skilled in the art that various modifications and variations can be made to the disclosed embodiments. It is intended that the specification and examples be considered as exemplary only, with a true scope of the present invention being indicated by the following claims and their equivalents.

What is claimed is:

1. A position-detecting radio frequency identification (RFID) device, comprising:
a pair of first radio frequency antennas transmitting and receiving a radio frequency signal;
a first RFID chip electrically connected to and corresponding to the pair of first radio frequency antennas, storing a signal containing position information, and transmitting the signal through the pair of first radio frequency antennas;
a pair of first electronic switches electrically connected to the pair of first radio frequency antennas and the first RFID chip in series, wherein one of the pair of first electronic switches is provided between one of the pair of first radio frequency antennas and the first RFID chip, another one of the pair of first radio frequency antennas is provided between another one of the pair of first radio frequency antennas and the first RFID chip; and
a switch control device controlling the pair of first electronic switches, wherein if the pair of first electronic switches are in the on state, the pair of first radio frequency antennas and the first RFID chip are electrically connected, and if the pair of first electronic switches are in the off state, the pair of first radio frequency antennas and the first RFID chip are electrically disconnected.

2. The device according to claim 1, wherein the pair of first electronic switches is a pair of light-sensitive components, the switch control device comprises a pair of first light-emitting components and a light controller, the pair of light-sensitive components is sensitive to light emitted by the pair of first light-emitting components, the light controller controls the pair of first light-emitting components to emit light, and the switch control device enables the pair of first electronic switches to be in the on or off state.

3. The device according to claim 1, further comprising a RFID chip reader electrically connected to a reader radio frequency antenna, wherein the pair of first radio frequency antennas transmits the radio frequency signal to the reader radio frequency antenna or receives the radio frequency signal from the reader radio frequency antenna.

4. The device according to claim 1, further comprising a RFID reader electrically connected to a reader radio frequency antenna, wherein the reader radio frequency antenna transmits the radio frequency signal to the pair of first radio frequency antennas or receives the radio frequency signal from the pair of first radio frequency antennas.

5. The device according to claim 1, wherein the switch control device further comprises a pair of second light-emitting components, the light-controller controls the pair of second light-emitting components to emit light, and the switch control device enables a pair of second electronic switches to be in the on or off state.

6. The device according to claim 5, further comprising a pair of second radio frequency antennas and a second RFID chip that are electrically connected to the pair of second electronic switches in series, wherein one of the pair of the second electronic switches is provided between one of the pair of second radio frequency antennas and the second RFID chip, another one of the pair of second radio frequency antennas is provided between another one of the pair of the second radio frequency antennas and the second RFID chip, and if the pair of second light-emitting components illuminates the pair of second electronic switches, the pair of second radio frequency antennas and the second RFID chip are electrically connected, and if the pair of second light-emitting components does not illuminate the pair of second electronic switches, the pair of second radio frequency antennas and the second RFID chip are electrically disconnected.

7. The device according to claim 1, wherein the first RFID chip, the second RFID chip, the pair of first radio frequency antennas and the pair of second radio frequency antennas work at least one frequency band ranging from 10 KHz to 134.2 KHz, from 1 MHz to 400 MHz, from 400 MHz to 960 MHz or greater than 1 GHz.

8. The device according to claim 2, wherein the pair of light-sensitive components is a pair of light-sensitive resistors, the pair of first radio frequency antennas receives a frequency outside of a frequency band when the pair of first frequency antennas and the first RFID chip are disconnected, and impedance matching of the pair of first frequency antennas is affected by the pair of light-sensitive resistors.

9. The device according to claim 2, wherein the pair of light-sensitive components is a pair of light-sensitive switches; the pair of first radio frequency antennas, the pair of light-sensitive switches and the first RFID chip are electrically connected in series, and the light control device enables the pair of light-sensitive switches to be in the on or off state; and if the pair of light-sensitive switches is in the on state, the pair of first radio frequency antennas and the first RFID chip are electrically connected, and if the pair of light-sensitive switches is in the off state, the pair of first radio frequency antennas and the first RFID chip are electrically disconnected.

10. The device according to claim 2, wherein the pair of light-sensitive components is a pair of light-sensitive switches; the pair of first radio frequency antennas, the pair of light-sensitive switches and the first RFID chip are connected in parallel, and the light control device enables the pair of light-sensitive switches to be in the on or off state; and if the pair of light-sensitive switches is in the off state, the pair of first radio frequency antennas and the first RFID chip are electrically connected, and if the pair of light-sensitive switches is in the on state, the pair of first radio frequency antennas and the first RFID chip are electrically disconnected.

11. The device according to claim 1, further comprising a light-sensitive energy storage component, wherein the switch control device comprises a pair of first light-emitting components and a light controller, the pair of first radio frequency antennas, the pair of first electronic switches and the first RFID chip are electrically connected in series, and the light-sensitive energy storage component is electrically connected to the pair of first electronic switches; the switch control device enables the pair of first electronic switches to be in the on or off state by illuminating the light-sensitive energy storage component; and if the pair of first electronic switches is in the on state, the pair of first radio frequency antennas and the first RFID chip are electrically connected, and if the pair of first electronic switches is in the off state, the pair of first radio frequency antennas and the first RFID chip are electrically disconnected.

12. The device according to claim 1, further comprising a light-sensitive energy storage component, wherein the switch control device comprises a pair of first light-emitting components and a light controller; the pair of first radio frequency antennas, the pair of first electronic switches and the first RFID chip are electrically connected in parallel, and the light-sensitive energy storage component is connected to the pair of first electronic switches; the switch control device enables the pair of first electronic switches to be in the on or off state by illuminating the light-sensitive energy storage component; and if the pair of first electronic switches is in the off state, the pair of first radio frequency antennas and the first RFID chip are electrically connected, and if the pair of first electronic switches is in the on state, the pair of first radio frequency antennas and the first RFID chip are electrically disconnected.

13. The device according to claim 1, wherein the first RFID chip, the pair of first electronic switches and the pair of first radio frequency antennas are mounted on a circuit board, and the pair of first light-emitting components, the light controller and the RFID reader are mounted in a cabinet or a place nearby.

14. The device according to claim 1, wherein the first RFID chip, the pair of first electronic switches and the pair of first radio frequency antennas are mounted on a circuit board.

15. A position-detecting radio frequency identification (RFID) method, comprising the steps of:
providing a pair of radio frequency antennas, a RFID chip storing a signal containing position information, an pair of electronic switches, a switch control device and a RFID reader, wherein one of the pair of electronic switches is provided between one of the pair of radio frequency antennas and the RFID chip, another one of the pair of radio frequency antennas is provided between another one of the pair of radio frequency antennas and the RFID chip, and the pair of radio frequency antennas, the pair of electronic switches and the RFID chip are electrically connected in series, and the switch control device controls the pair of electronic switches;
enabling the pair of electronic switches to be in the off state to initially disconnect the RFID chip and the pair of radio frequency antennas;
enabling the pair of electronic switches to be in the on state by using the switch control device while the RFID chip connected to the pair of electronic switches is detected, wherein the pair of radio frequency antennas transmits the signal containing position information stored in the RFID chip to the reader radio frequency antenna of the RFID reader; and
reading the signal containing position information stored in the RFID chip by the RFID reader while the pair of electronic switches connected to the RFID chip is in the on state, and obtaining position information of the RFID chip.

16. The method according to claim 15, wherein the pair of electronic switches is a pair of light-sensitive switches, the switch control device comprises a pair of light-emitting components and a light controller, the light controller controls the pair of light-emitting components to emit light, and the pair of light-emitting components illuminates the pair of light-sensitive switches to enable the pair of light-sensitive switches to be in the on state.

17. The method according to claim 15, wherein the step of providing comprises a step that the RFID chip, the pair of electronic switches and the pair of radio frequency antennas are electrically connected in series; if the pair of electronic switches is in the on state, the RFID chip and the pair of radio frequency antennas are electrically connected, and if the pair of electronic switches is in the off state, the RFID chip and the pair of radio frequency antennas are electrically disconnected.

18. The method according to claim 15, wherein the step of providing comprises a step that the RFID chip, the pair of electronic switches and the pair of radio frequency antennas are electrically connected in parallel; if the pair of electronic switches is in the off state, the RFID chip and the pair of radio frequency antennas are electrically connected, and if the pair of electronic switches is in the on state, the RFID chip and the pair of radio frequency antennas are electrically disconnected.
